(19) United States
(12) Patent Application Publication
(10) Pub. No.: US 2026/0225708 A1
(43) Pub. Date: Aug. 6, 2026

(54) PITCH-CHANGE MECHANISM WITH LOCKING DEVICE

(71) Applicant: Safran Aircraft Engines, PARIS (FR)

(72) Inventors: Jean Charles Olivier RODA, MOISSY-CRAMAYEL (FR); Clément COTTET, MOISSY-CRAMAYEL (FR); Ceddric BELJAMBE, MOISSY-CRAMAYEL (FR); Caroline Marie FRANTZ, MOISSY-CRAMAYEL (FR)

(73) Assignee: Safran Aircraft Engines, PARIS (FR)

(21) Appl. No.: 19/151,704

(22) PCT Filed: Jan. 31, 2024
(86) PCT No.: PCT/FR2024/050125

§ 371 Date: Jul. 29, 2025

(30) Foreign Application Priority Data
Feb. 1, 2023 (FR) FR2300922

(51) Int. Cl. B64C 11/38; F01D 7/00

(52) U.S. Cl. CPC B64C 11/385; F01D 7/00; F05D 2220/323; F05D 2220/36

(57) ABSTRACT

This pitch-change mechanism (70) comprises a frame (72), a moving part (102) which is translatably moveable along a longitudinal axis (X), and a locking device (160) for immobilising the moving part (102) relative to the frame (72). The locking device (160) comprises a blocking surface (162), a guide surface (164) and a blocking member (166) interposed therebetween. It further comprises a biasing member (200) which urges the guide surface (164) and the blocking member (166) toward one configuration of one relative to the other and a holding device (202) for holding the guide surface (164) and the blocking member (166) in another configuration under certain predetermined conditions.

### FIELD OF THE INVENTION

The present invention relates to the general field of actuators intended for controlling the orientation of variable-setting blades such as those equipping the fans of certain turbomachines.

A preferred field of application of the invention is that of turbojets with unducted fans (better known under the names “propfan”, “open fan” and “open rotor”). However, the invention also applies to turboprops with one or more pusher propellers and to ducted turbojets with variable-setting fan blades.

### TECHNOLOGICAL BACKGROUND

One of the avenues currently being explored to improve the specific consumption of civil aircraft engines is the development of unducted fan turbojets, such as that described in document FR 2 941 493. These turbojets include a conventional turboshaft gas generator, one or more turbine stages of which drive one or more unducted fans extending outside the engine nacelle.

The blades of this or these fans are, as in the case of conventional turboprops, variable-setting fans, that is to say that the angular position of these blades (called the setting angle) can be modified during flight. As a reminder, the setting angle of a blade corresponds to the angle, in a plane orthogonal to the pivot axis of the blade, between the axis of rotation of the fan and the chord of the blade at 75% of the radius of the fan. It can vary from a value substantially equal to 90°, corresponding to a position called “zero thrust position” or “flat pitch” of the blade, to a value substantially equal to 0°, corresponding to a position called “feathered” position of the blade. It can also take a value strictly greater than 90°, typically substantially equal to 95°, corresponding to a position called “reverse” position of the blade.

As is known, this modification of the setting angle during flight allows to change the engine thrust and optimize the efficiency of the fan according to the aircraft speed. Indeed, the speed of the fans is almost constant overall operating phases, and it is the setting of the blades that varies the thrust. Thus, in the cruise flight phase, the blades are oriented so as to adjust the thrust by minimizing the power taken from the turbine shaft and consumption and by optimizing efficiency. Conversely, during takeoff, the blades are oriented so as to maximize the thrust in order to accelerate then take off the aircraft.

The control of the orientation of the blades is commonly carried out by means of a pitch-change mechanism comprising a control actuator including a part which is translatably movable along the axis of the fan and a connection system connecting the moving part to the blade so as to convert the translation of the moving part into rotation of the variable-setting blade.

A difficulty encountered with variable-setting blades is that, in the event of a malfunction in the systems controlling their orientation, said blades tend, under their own centrifugal effect, to switch into the zero thrust position. However, a blade stuck in this position generates little resistive torque and risks causing the engine to overspeed, with potential risks of engine damage. In addition, a blade stuck in this position also risks generating excessive drag that is unacceptable for the controllability of the aircraft and/or its range in the case of a diversion mission.

To overcome this difficulty, it is known to use safety systems capable of preventing the variable-setting blades from moving toward small pitches (that is to say toward the zero thrust position) in the event of a failure of the blade orientation control system. Such a system is known, for example, from EP 3 400 169.

In particular, a safety system is known which integrates into the actuator controlling the orientation of the blades a screw-nut system of the ball screw type coupled to a locking nut. In normal operation, the nut of the screw-nut system follows the movements of the control actuator, thus causing the rotation of the screw around its axis, while the locking nut follows the thread of the screw without ever touching it (the tapping of the locking nut is designed to provide a slight clearance with the thread of the screw). In the event of a malfunction of the blade orientation control system, the screw of the screw-nut system is immobilized (its rotation is blocked) and the locking nut engages with said screw, thus preventing the pivoting of the blades toward the small pitches.

However, this safety system is not entirely satisfactory. For it to work properly, it requires precise and complex management of the clearances between the locking nut and the screw thread.

### DISCLOSURE OF THE INVENTION

One purpose of the invention is to enable, in a simple and robust manner, the locking the blade setting angle in at least one direction. Other purposes are to enable the locking the blade setting angle in their current orientation (with a certain tolerance), to enable locking in the absence of power supply to the actuator, to enable locking and/or unlocking with a low force, and to limit the size of the locking mechanism.

To this end, the invention relates, according to a first aspect, to a pitch-change mechanism for adjusting an angular position of at least one variable-setting blade of an aircraft turbomachine around a pivot axis of the blade, said pitch-change mechanism comprising:
a frame fixed relative to the pivot axis,
a control actuator including a fixed part integral with the frame and a moving part,
a connecting system connecting the moving part to the variable-setting blade so as to convert the movement of the moving part relative to the fixed part into a rotation of the variable-setting blade around the pivot axis, and
a pitch locking device suitable for blocking the movement of the moving part relative to the fixed part in at least one direction,

wherein the pitch locking device comprises:
a blocking surface integral with the frame or movable jointly with the moving part relative to the frame,
a guide surface facing the blocking surface and comprising a surface portion at a first, fixed distance from the blocking surface,
a blocking member interposed between the blocking surface and the guide surface and having a guide face facing the guide surface, said blocking member having an unlocking configuration spaced from the blocking surface, in which a face portion of the guide face is at a second distance from the blocking surface, greater than the first distance, and a locking configuration engaged with the blocking surface so that the moving part is immobilized relative to the frame, in which the face portion is at the first distance from the blocking surface,

the guide surface and the blocking member being movable relative to each other parallel to the blocking surface between a first configuration, in which the surface portion is spaced from the face portion, and a second configuration in which the face portion bears against the surface portion,

the pitch locking device further comprising:
a biasing member urging the guide surface or the blocking member toward the second configuration, and
a holding device for holding the guide surface and the blocking member in the first configuration under certain predetermined conditions.

According to particular embodiments of the invention, the pitch-change mechanism also has one or more of the following features, taken in isolation or in any technically possible combination(s):
the predetermined conditions consist of a supply pressure of the chambers of the control actuator greater than a threshold, said threshold being lower than a minimum supply pressure of the chambers of the control actuator under normal operating conditions;
the blocking surface is movable jointly with the moving part relative to the frame and is preferably integral with the moving part,
in the first configuration, the blocking member is free to be in its unlocking configuration and, in the second configuration, the blocking member is forced into its locking configuration;
the guide surface is translatably movable parallel to the blocking surface relative to the blocking surface;
the guide surface converges toward the blocking surface;
the guide surface converges toward the blocking surface in a first direction, the biasing member exerting on the guide surface a force oriented in a second direction opposite to the first direction and/or exerting on the blocking member a force oriented in said first direction;
the blocking member comprises a blocking face facing the blocking surface, the guide face converging toward said blocking face;
the guide face converges toward the blocking face in a first direction, the biasing member exerting on the guide surface a force oriented in a second direction opposite to the first direction and/or exerting on the blocking member a force oriented in said first direction;
the guide face is substantially parallel to the guide surface;
the blocking surface is cylindrical and the blocking member is annular and substantially coaxial with the blocking surface, the blocking member being circumferentially divided into several segments movable relative to each other between a close configuration, in which the blocking member has a reduced diameter, and a spaced configuration, in which the blocking member has an increased diameter, the close configuration constituting one of the locking and unlocking configurations of the blocking member and the spaced configuration constituting the other of said locking and unlocking configurations;
the blocking surface is cylindrical and the blocking member comprises a split sleeve substantially coaxial with the blocking surface;
the blocking member surrounds the blocking surface;
the blocking surface surrounds the blocking member;
the guide surface is annular and substantially coaxial with the blocking surface;
the holding device comprises a counterbalancing actuator with a counterbalancing chamber in contact with a piston movable together with the guide surface or the blocking member, said counterbalancing chamber being capable of receiving a pressurized fluid to counterbalance the urge of the biasing device;
the moving part is translatably movable along a longitudinal axis relative to the fixed part;
one of the blocking surface and the blocking member is interposed between the longitudinal axis and the other of the blocking surface and the blocking member;
the blocking surface is cylindrical and substantially coaxial with the longitudinal axis;
one of the guide surface and the blocking member is translatably movable relative to the frame in a secondary translation direction substantially parallel to the blocking surface, the other of the guide surface and the blocking member being substantially fixed relative to the frame in said secondary translation direction,
the secondary translation direction is substantially parallel to the longitudinal axis;
the control actuator comprises a large pitch chamber, adapted so that a relative increase in pressure in said large pitch chamber causes rotation of the variable-setting blade toward the large pitches, and a small pitch chamber adapted so that a relative increase in pressure in said small pitch chamber causes rotation of the variable-setting blade toward the small pitches;
the guide surface converges toward the blocking surface in a direction from the large pitch chamber toward the small pitch chamber; and
the guide face converges toward the blocking face in a direction from the large pitch chamber toward the small pitch chamber.

The invention also relates, according to a second aspect, to a fan rotor for a turbomachine comprising a hub and a plurality of variable-setting blades each pivotable relative to the hub around a specific pivot axis, the rotor further comprising a pitch-change mechanism according to the first aspect for adjusting an angular position of each of the variable-setting blades around its respective pivot axis.

According to a particular embodiment of the invention, the fan rotor also has the following feature:
the longitudinal axis constitutes an axis of rotation of the rotor.

The invention also relates, according to a third aspect, to a gas turbine engine comprising a fan rotor according to the second aspect.

According to a particular embodiment of the invention, the gas turbine engine also has the following feature:
the longitudinal axis constitutes an axis of elongation of the gas turbine engine.

The invention also relates, according to a fourth aspect, to an aircraft comprising at least one gas turbine engine according to the third aspect.

Finally, the invention relates, according to a fifth aspect, to a method for changing the pitch of the blades of a fan rotor for a turbomachine, each pivotable relative to a hub of the fan rotor around a specific pivot axis, said method comprising adjusting an angular position of each of said blades around its respective pivot axis by means of a pitch changing mechanism according to the first aspect.

According to a particular embodiment of the invention, the method also has the following feature:
the method comprises an additional step of locking the orientation of the blades by means of the pitch locking device.

### BRIEF DESCRIPTION OF THE FIGURES

Other features and advantages of the invention will appear upon reading the description which follows, given only by way of example and made with reference to the appended drawings, in which:

FIG. 1 is a top view of an aircraft according to an exemplary embodiment of the invention,

FIG. 2 is a simplified longitudinal sectional view of a gas turbine engine of the aircraft of FIG. 1,

FIG. 3 is a partial simplified view, in longitudinal section, of a first embodiment of a pitch-change mechanism of the gas turbine engine of FIG. 2,

FIG. 4 is a partial simplified view, in longitudinal section, of a first variant of a pitch locking device of the pitch-change mechanism of FIG. 3, said pitch locking device being in a first configuration,

FIG. 5 is a view similar to that of FIG. 4, with the pitch locking device in a second configuration,

FIG. 6 is a simplified view along a radial axis of a rotating arm of a variable-setting blade of the turbomachine of FIG. 2,

FIGS. 7 and 8 are front views of a blocking member of the locking device of FIGS. 4 and 5,

FIG. 9 is a view similar to that of FIG. 3 of a second embodiment of the pitch-change mechanism of the gas turbine engine of FIG. 2,

FIG. 10 is a partial simplified view, in longitudinal section, of a first variant of a pitch locking device of the pitch-change mechanism of FIG. 9, said pitch locking device being in a first configuration,

FIG. 11 is a view similar to that of FIG. 10, with the pitch locking device in a second configuration,

FIG. 12 is a partial simplified view, in longitudinal section, of a second variant of the pitch locking device of the pitch-change mechanism of FIG. 9, said pitch locking device being in a first configuration,

FIG. 13 is a view similar to that of FIG. 12, with the pitch locking device in a second configuration,

FIG. 14 is a partial simplified view, in longitudinal section, of a third variant of the pitch locking device of the pitch-change mechanism of FIG. 9, said pitch locking device being in a first configuration, and

FIG. 15 is a view similar to that of FIG. 14 with the pitch locking device in a second configuration.

### DETAILED DESCRIPTION OF AN EXEMPLARY EMBODIMENT

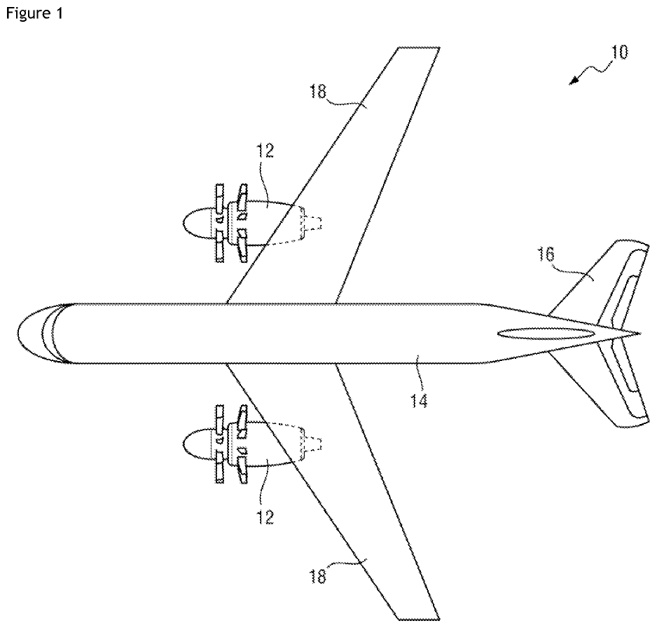

The aircraft 10 shown in FIG. 1 comprises turbomachines 12 forming gas turbine engines to propel it.

In the example shown, the aircraft 10 is an airplane. This aircraft comprises, in a conventional manner, a fuselage 14, a tailplane 16 and two wings 18. The gas turbine engines 12 are here two in number and are each housed under a respective wing 18. As a variant (not shown), the gas turbine engines 12 are arranged along the fuselage 14, for example near the tailplane 16. As a further variant (also not shown), the aircraft 10 comprises a single gas turbine engine 12 or at least three gas turbine engines 12.

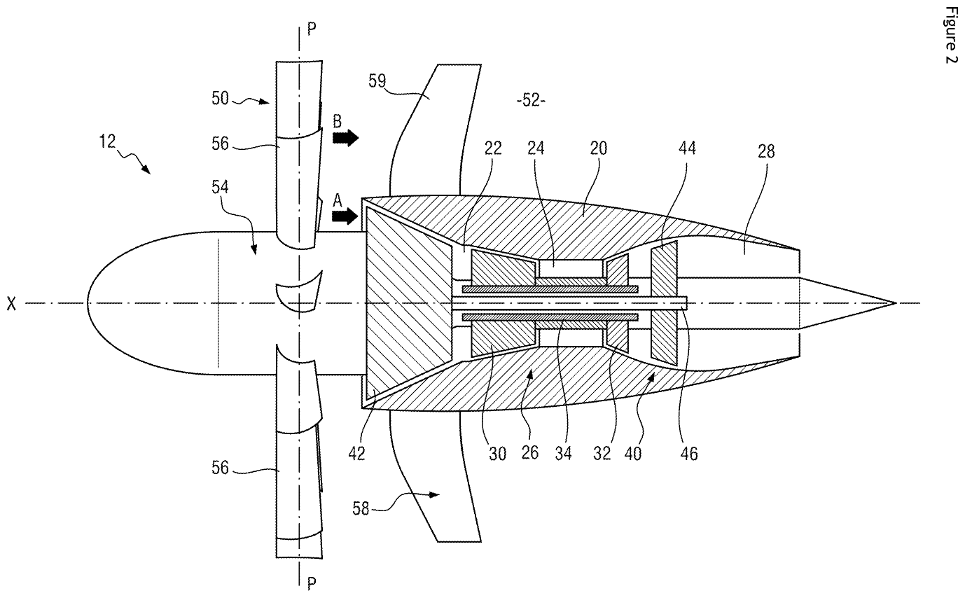

One of the turbomachines 12 is shown in FIG. 2.

As visible in this FIG. 2, the turbomachine 12 is elongated along a longitudinal axis X. It typically has an angular symmetry around said longitudinal axis X, that is to say that there is at least one angle for which the turbomachine is invariant by rotation around the longitudinal axis X.

Here and hereinafter, the terms “interior” and “exterior”, “internal” and “external”, as well as their variations, are understood in reference to the axis X, an element described as “interior” or “internal” being oriented toward the axis X while an “exterior” or “external” element is oriented opposite the axis X.

The turbomachine 12 comprises, in a conventional manner, a nacelle 20, an internal flow path 22 for circulating an air flow through the nacelle 20, a combustion chamber 24 housed in the flow path 22, an engine spool 26 and a gas exhaust nozzle 28.

In the following, the terms “upstream” and “downstream” are understood to refer to a direction of flow of an air flow through the flow path 22.

The engine spool 26 comprises a compressor 30, a turbine 32 and a transmission shaft 34 coupling the turbine 32 to the compressor 30 for driving the compressor 30 by the turbine 32. The compressor 30 is arranged upstream of the combustion chamber 24 and supplies the combustion chamber 24 with compressed air. The turbine 32 is arranged downstream of the combustion chamber 24 and receives the exhaust gases leaving the combustion chamber 24.

The transmission shaft 34 has the longitudinal axis X as its axis of rotation.

The transmission shaft 34 is guided in rotation relative to the nacelle 20 by means of bearings (not shown).

In the example shown, the turbomachine 12 is a multi-spool turbomachine, in particular a twin-spool turbomachine, comprising a low-pressure spool 40 in addition to the engine spool 26. The engine spool 26 then constitutes a high-pressure spool, the compressor 30 being a high-pressure compressor, the turbine 32 being a high-pressure turbine and the transmission shaft 34 being a high-pressure shaft.

The low-pressure spool 40 comprises a low-pressure compressor 42, a low-pressure turbine 44 and a low-pressure shaft 46 coupling the low-pressure turbine 44 to the low-pressure compressor 42 for driving the low-pressure compressor 42 by the low-pressure turbine 44.

The low-pressure compressor 42 is arranged upstream of the high-pressure compressor 30 and supplies the latter with compressed air. The low-pressure turbine 44 is arranged downstream of the high-pressure turbine 32 and receives the exhaust gases leaving the latter.

The low-pressure shaft 46 is guided in rotation relative to the nacelle 20 by means of bearings (not shown).

The low-pressure shaft 46 is coaxial with the high-pressure shaft 34. Therefore, it also has the longitudinal axis X as its axis of rotation. In particular, the low-pressure shaft 46 extends inside the high-pressure shaft 34.

The turbomachine 12 also comprises a fan 50 for driving the air flow in an external circulation flow path 52 surrounding the nacelle 20. A primary (hot) air flow A is thus distinguished, consisting of the portion of the air flow driven in the internal circulation flow path 22, and a secondary (cold) air flow B, consisting of the portion of the air flow driven in the external circulation flow path 52.

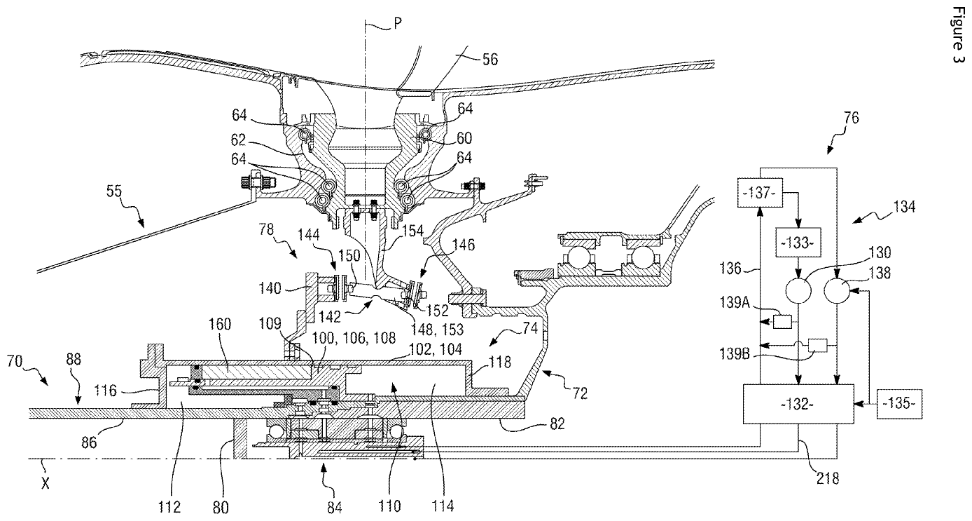

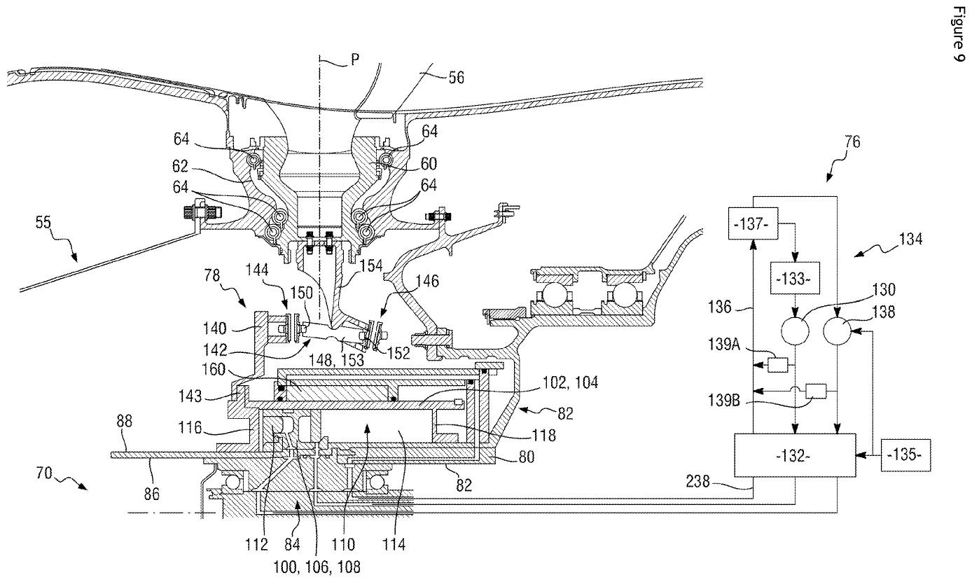

The fan 50 comprises a fan rotor 54. This fan rotor 54 is rotatably mounted relative to the nacelle 20 around the longitudinal axis X. It comprises a hub 55 (FIGS. 3 and 9) provided with fan blades 56 extending substantially radially outward from the hub 55. These blades 56, when rotated, drive the air flow in the external circulation flow path 52.

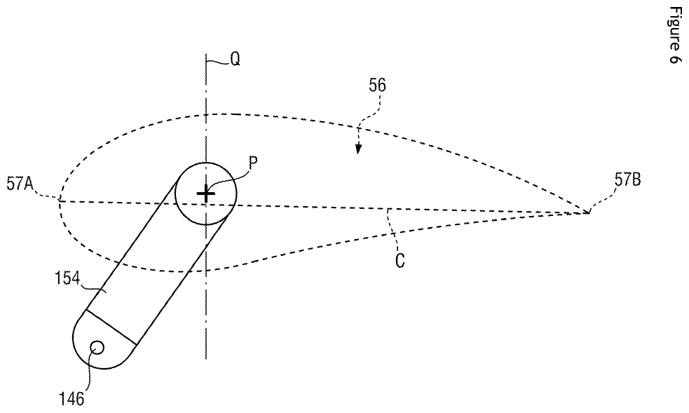

As seen in FIG. 6, each blade 56 comprises a leading edge 57A, a trailing edge 57B and a chord C connecting the leading edge 57A to the trailing edge 57B.

Returning to FIG. 2, the fan rotor 54 is driven in rotation by the low-pressure turbine 44, via the low-pressure shaft 46. This drive is preferably done via a reducer (not shown) allowing the fan rotor 54 to rotate at a speed lower than that of the low-pressure shaft 46. Alternatively, this drive is direct, that is to say that the fan rotor 54 is integral in rotation with the low-pressure shaft 46.

In the example shown, the fan 50 also comprises a fan stator 58 comprising fixed blades 59 arranged at the periphery of the nacelle 20, in the external circulation flow path 52, along a plane orthogonal to the longitudinal axis X. This fan stator 58 is here arranged downstream of the fan rotor 54. As a variant (not shown), the fan 50 comprises, instead of the fan stator 58, a counter-rotating fan rotor.

Advantageously, the fan 50 is, as shown, unducted, that is to say that the external circulation flow path 52 has no peripheral delimitation. The turbomachine 12 is then constituted, as shown, by a turbojet engine with an unducted fan or, as a variant, by a turboprop. As a variant (not shown), the external circulation flow path 52 is defined between the nacelle 20 and a fan casing surrounding the fan 50; the turbomachine 12 is then typically constituted by a turbojet engine with a high bypass ratio, the bypass ratio being defined as the ratio of the flow rate of the secondary (cold) flow B to the flow rate of the primary (hot) flow A.

In the example shown, the turbomachine 12 is in particular of the “puller” type, that is to say that the fan 50 is arranged upstream of the internal circulation flow path 22 and also drives the air flow in the latter. As a variant (not shown), the turbomachine is of the “pusher” type, that is to say that the fan 50 is placed around the downstream half of the nacelle 20.

The blades 56 of the fan rotor 54 are variable-setting blades, that is to say that each blade 56 is pivotally mounted relative to the hub 55 around a specific pivot axis P. This pivot axis P extends in the direction of elongation of the blade 56. It is substantially orthogonal to the longitudinal axis X.

Each blade 56 is in particular able to pivot around the axis P relative to the hub 55 between a position called feathered position, in which the chord C of the blade 56 is substantially parallel to the longitudinal axis X, and a position called zero thrust position, in which the chord C of the blade 56 is substantially orthogonal to the longitudinal axis X. Preferably, each blade 56 is also able to pivot beyond the zero thrust position, to a position called reverse position, in which the chord C of the blade 56 forms an angle strictly greater than 90°, for example substantially equal to 95°, with the longitudinal axis X. The blades 56 being most often twisted, the chord C taken as a reference for measuring the setting angle is, by convention, constituted by the chord of the blade at 75% of the radius of the fan rotor 54.

For this purpose, each blade 56 is integral, as visible in FIGS. 3 and 9, with an attachment component 60 arranged at the blade root. This attachment component 60 is rotatably mounted relative to the hub 55 around the pivot axis P. More precisely, the attachment component 60 is rotatably mounted inside a housing 62 formed in the hub 55 by means of balls 64 or other rolling elements.

The fan 50 further comprises a pitch-change mechanism 70 for adjusting the setting angle of each blade 56 around its pivot axis P so as to adapt the performance of the turbomachine 12 to the different phases of flight.

With reference to FIGS. 3 to 5, a first exemplary embodiment of this pitch-change mechanism 70 will now be described.

As seen in FIG. 3, the pitch-change mechanism 70 comprises a frame 72, a control actuator 74, a system 76 for controlling the actuator 74 and a connection system 78.

The frame 72 is integral with the hub 55 and is typically constituted by a part of the hub 55. It is thus fixed relative to the pivot axes P.

The frame 72 comprises a base 80. This base 80 is centered on the longitudinal axis X. Here, it is traversed by the pivot axes P.

In the example shown, the base 80 delimits a housing 82 open downstream. This housing 82 is in particular cylindrical, typically cylindrical of revolution, and centered on the axis X. An oil transfer bearing 84 is received in said housing 82.

In the example shown, the frame 72 also comprises a cylinder 86 projecting upstream from the base 80. This cylinder 86 is centered on the axis X. It is typically cylindrical of revolution.

The base 80 and the peripheral cylinder 86 together delimit an external peripheral surface 88 of the frame 72. This external peripheral surface 88 is substantially cylindrical and centered on the axis X. It is oriented radially outwards.

The control actuator 74 includes a fixed part 100, integral with the frame 72, and a moving part 102 which is translatably movable along the longitudinal axis X relative to the fixed part 100 between a retracted position, shown in FIG. 3, and a deployed position (not shown). Optionally, the moving part 102 is also rotatably movable around the longitudinal axis X over a restricted angle, for example of the order of 5°.

The control actuator 74 comprises in particular a continuous cylinder 104, forming one of the fixed part 100 and the moving part 102 and a piston 106 forming the other of the fixed part 100 and the moving part 102. Here, the cylinder 104 forms the moving part 102 and the piston 106 forms the fixed part 100. As a variant (not shown), the opposite is true: the cylinder 104 forms the fixed part 100 and the piston 106 forms the moving part 102.

Thus, in the example shown, the cylinder 104 extends around the external peripheral surface 88 of the frame 72, coaxially with the latter, and the piston 106 is constituted by a collar 108 integral with the frame 72 extending radially outwards from the external peripheral surface 88 to the cylinder 104.

The piston 106 has an external face 109 in contact with the cylinder 104.

The cylinder 104 defines an internal cavity 110. The piston 106 divides said internal cavity 110 into two contiguous fluid chambers 112, 114. Each contains a control fluid, typically constituted by an oil, for controlling the movement of the moving part 102 relative to the fixed part 100. This control fluid is at a first pressure in the first fluid chamber 112 and at a second pressure in the second fluid chamber 114. The first and second fluid chambers 112, 114 are arranged such that the relative increase in the first pressure (that is to say, relative to the second pressure) causes the piston 110 to move toward its deployed position, the relative increase in the second pressure (that is to say, relative to the first pressure) causes the piston 110 to move toward its retracted position.

Here, each of the fluid chambers 112, 114 is delimited internally by the external peripheral surface 88 of the frame 72 and externally by the cylinder 104. The first fluid chamber 112 is moreover delimited at its downstream end by the piston 106 and the second fluid chamber 114 is delimited at its upstream end by the piston 106.

The control actuator 74 is thus particularly compact, which makes it lighter.

In the example shown, the moving part 102 also comprises an upstream guide ring 116 and a downstream guide ring 118 each integral with the cylinder 104 and extending radially inwards from the cylinder 104 to the external peripheral face 88 of the frame 72. The upstream guide ring 116 is arranged upstream of the piston 106 and delimits an upstream end of the first fluid chamber 112. The downstream guide ring 118 is arranged downstream of the piston 106 and delimits a downstream end of the second fluid chamber 114.

In the example shown, each of the upstream and downstream guide rings 116, 118 constitutes a sealing ring and longitudinally closes the first fluid chamber 112, respectively the second fluid chamber 114. The fluid chambers 112, 114 are thus closed at each of the longitudinal ends of the control actuator 74.

As a variant (not shown), only the downstream guide ring 118 constitutes a sealing ring. The upstream guide ring 116 has holes allowing the control fluid to flow through the upstream guide ring 116.

As a further variant (not shown), the moving part 102 does not comprise an upstream guide ring 116.

The control system 76 comprises a pressure generator 130 for bringing the control fluid to a third pressure higher than the first and second pressures, a pressure control unit 132 for adjusting the pressure of the control fluid in the first and second fluid chambers 112, 114 by means of the third pressure, and a return line 136 for discharging the depressurized control fluid. The control system 76 also comprises a main reservoir 133, a backup circuit 134 and a control module 135.

The pressure generator 130 comprises, for example, a pump capable of pumping the fluid to bring it to the third pressure, for example 100 bars. A main pressure relief valve 139A allows to evacuate part of the control fluid to the return line 136 when the pressure of the control fluid downstream of the pressure generator 130 exceeds the third pressure.

The pressure control unit 132 is supplied with control fluid at the third pressure by the pressure generator 130. It is fluidically connected to the first fluid chamber 112 and to the second fluid chamber 114 via the oil transfer bearing 84. It is able to distribute the control fluid between the first fluid chamber 112 and the second fluid chamber 114 so as to adjust the fluid pressure inside each of these chambers 112, 114 and, thus, adjust the position of the piston 110 between its retracted and deployed positions. It is also able to discharge control fluid from the first and second fluid chambers 112, 114 into the return line 136.

The main reservoir 133 is configured to collect depressurized control fluid from the return line 136. It supplies the pressure generator 130.

The emergency circuit 134 is capable of supplying the first fluid chamber 112 with control fluid so as to move the piston 110 toward its deployed position in the event of failure of the pressure generator 130. For this purpose, the emergency circuit 134 comprises an auxiliary reservoir 137 and an auxiliary pump 138. In the example shown, it also comprises an auxiliary pressure relief valve 139B.

The auxiliary reservoir 137 is configured to collect depressurized control fluid from the return line 136. It feeds the auxiliary pump 138. In the example shown, it also feeds the main tank 133, with the depressurized control fluid from the return line 136 passing through the auxiliary reservoir 137 before reaching the main tank 133.

The auxiliary pump 138 is capable of pumping the control fluid into the auxiliary reservoir 137 to bring it to the third pressure. It is fluidically connected to the pressure control unit 132 so as to supply it with control fluid at the third pressure, the pressure control unit 132 being configured to redirect all the control fluid coming from the auxiliary pump 138 to the first fluid chamber 112.

The pressure relief valve 139B is adapted to discharge part of the control fluid to the return line 136 when the pressure of the control fluid downstream of the auxiliary pump 138 exceeds the third pressure.

The control module 135 is configured to receive a setting instruction (not shown) and deduce therefrom a control signal transmitted to the pressure control unit 132. In particular, the control module 135 is configured to transmit to the pressure control unit 132 a control signal intended to increase the fluid pressure in the first chamber 112 when the setting instruction aims at increasing the pitch of the blades 56, and to transmit to the pressure control unit 132 a control signal intended to increase the fluid pressure in the second chamber 114 when the setting instruction aims at reducing the pitch of the blades 56. The first chamber 112 thus constitutes a large pitch chamber, adapted so that a relative increase in pressure in said chamber 112 causes a rotation of the blades 56 toward the large pitches, and the chamber 114 constitutes a small pitch chamber adapted so that a relative increase in pressure in said chamber 114 causes a rotation of the blades 56 toward the small pitches. The control module 135 is also configured to transmit to the emergency circuit 134, more particularly to its auxiliary pump 138, a start instruction in the event of failure of the pressure generator 130.

The connecting system 78 connects the moving part 102 to each blade 56 so as to convert the translation of the moving part 102 along the longitudinal axis X and, where appropriate, the rotation of the moving part 102 around the longitudinal axis X into a rotation of each blade 56 around its pivot axis P. In particular, the connecting system 78 connects the moving part 102 to each blade 56 so as to convert:
the translation of the moving part 102 along the longitudinal axis X in a first direction into a rotation of the variable-setting blade 56 around the pivot axis P toward the zero thrust position, and
the translation of the moving part 102 along the longitudinal axis X in a second direction opposite to the first direction into a rotation of the variable-setting blade 56 around the pivot axis P toward the feathered position.

For this purpose, the connection system 78 comprises a synchronization ring 140 integral with the moving part 102 and, for each of the blades 56, a mechanism 142 for connecting the blade 56 to the synchronization ring 140.

The synchronization crown 140 extends in a radial plane around the moving part 102. It is, in the first embodiment described herein, fixed to a middle portion of the moving part 102.

Each connecting mechanism 142 comprises a first articulation 144 integral with the moving part 102, a second articulation 146 integral with the blade 56, spaced from the pivot axis P of said blade 56, and a connecting member 148 connecting the first articulation 144 to the second articulation 146.

The first articulation 144 is carried by the synchronization crown 140. Here it is constituted by a ball joint.

The second articulation 146 is also constituted by a ball joint. It is eccentric relative to the pivot axis P.

The connecting member 148 has a first end 150 articulated to the first articulation 144 and a second end 152 articulated to the second articulation 146. Advantageously, the connecting member 148 is rigid and of adjustable length, that is to say that the distance between the first and second ends 150, 152 can be modified, which allows to precisely adjust the length thereof when stationary so as to allow the control of the setting angle of each blade 56 by the pitch-change mechanism 70.

The connecting member 148 is here constituted by a connecting rod 153.

In the example shown, each connecting mechanism 142 also comprises a crank 154 connecting the attachment component 60 to the second articulation 146. This crank 154 is rigid and integral with the attachment component 60. It extends at least partly in a direction orthogonal to the pivot axis P. It forms an arm for rotating the blade 56.

In the example shown, the first direction is from upstream to downstream, that is to say that the movement of the movable member 102 toward its retracted position causes a rotation of each blade 56 toward its zero thrust position, and the second direction is from downstream to upstream, that is to say that the movement of the movable member 102 toward its deployed position causes a rotation of each blade 56 toward its feathered position. In addition, the first articulation 144 is arranged upstream of the second articulation 146.

For this purpose, the second articulation 146 is, as visible in FIG. 6, placed opposite the trailing edge 57B relative to a plane Q orthogonal to the chord C and containing the pivot axis P.

As a variant (not shown), the first direction goes from downstream to upstream, the first articulation 144 being arranged downstream of the second articulation 146. The second articulation 146 is then placed on the same side of the trailing edge 57B relative to the plane Q orthogonal to the chord C and containing the pivot axis P.

These particular arrangements allow, when the pitch-change mechanism 70 is immobilized, that the natural urges of the blade 56 toward its zero thrust position cause the connecting member 148 to work in tension and not in compression. The risk of buckling of the connecting member 148 is therefore very low, so that it is possible to use a relatively weak connecting member 148 and thus to lighten the pitch-change mechanism 70.

The pitch-change mechanism 70 further comprises a pitch locking device 160 capable of blocking the translation of the moving part 102 of the control actuator 74 at least in the direction causing the rotation of the blades 56 toward the small pitches. In the first embodiment described herein, said locking device 160 is housed inside the control actuator 74.

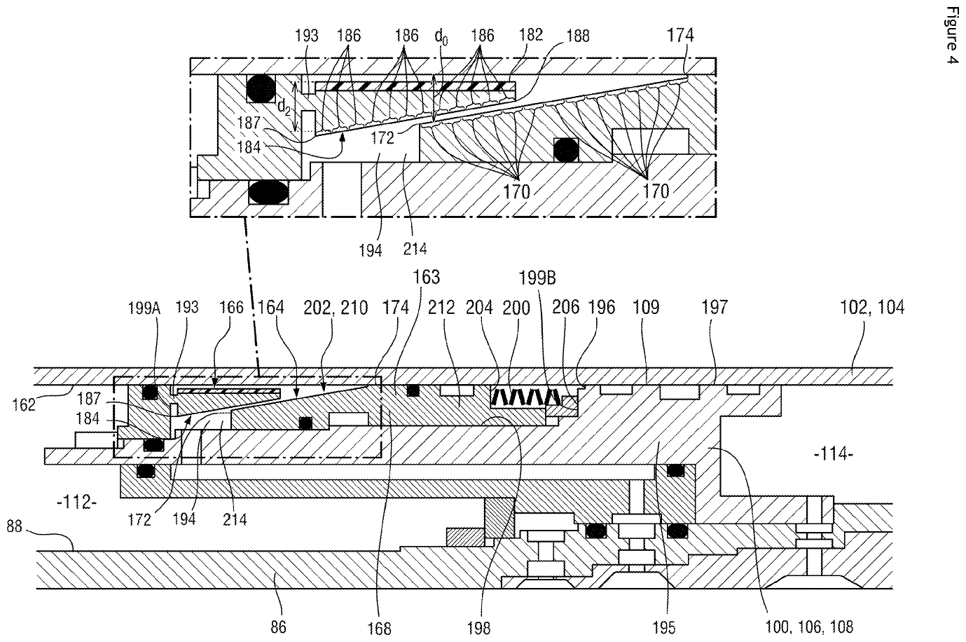

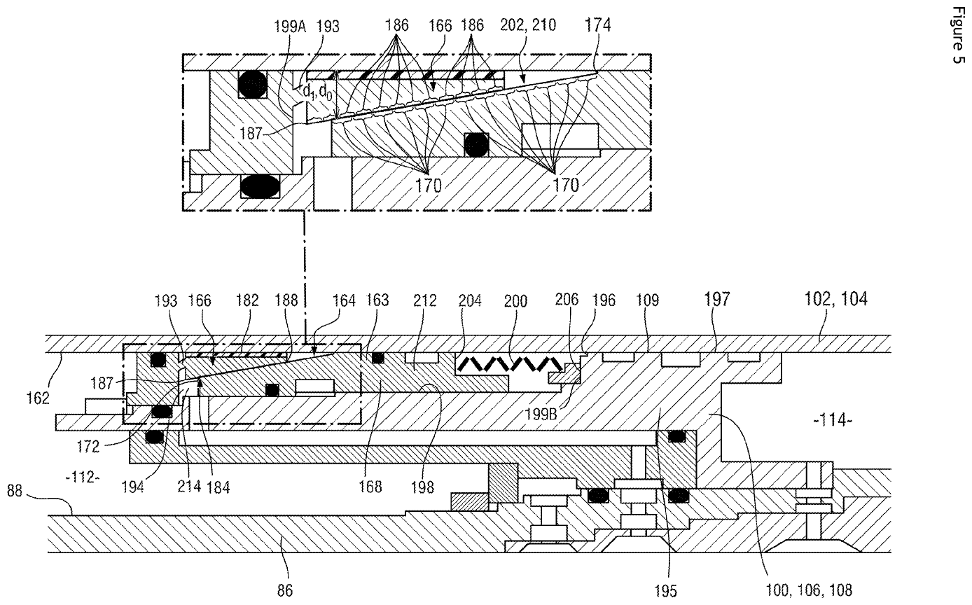

An exemplary embodiment of this locking device 160 will now be described, with reference to FIGS. 4 and 5.

The locking device 160 comprises a blocking surface 162 movable together with the moving part 102 relative to the fixed part 100, a guide component 163 delimiting a guide surface 164 facing the blocking surface 162 and a blocking member 166 interposed between the blocking surface 162 and the guide surface 164 to immobilize the moving part 102 relative to the fixed part 100 by engaging with the blocking surface 162.

The blocking surface 162 is particularly integral with the moving part 102.

The blocking surface 162 is translatably movable relative to the frame 72 in a primary translation direction. This primary translation direction is substantially parallel to the blocking surface 162. Advantageously, said primary translation direction is constituted by a direction of greater dimension of the blocking surface 162.

The blocking surface 162 is advantageously cylindrical, that is to say it has the shape of a cylinder. The primary translation direction is then preferably parallel to the axis of said cylinder. Moreover, the axis of said cylinder is advantageously substantially coincident with the axis X, that is to say the blocking surface is substantially coaxial with the axis X.

The blocking surface 162 is in particular carried directly by the moving part 102. In the first embodiment described herein, it constitutes an internal surface of the cylinder 104.

Typically, the blocking surface 162 is substantially smooth.

The guide surface 164 is positioned relative to the blocking surface 162 such that one of the guide surface 164 and the blocking surface 162 is interposed between the axis X and the other of the guide surface 164 and the blocking surface 162. Thus, in the first embodiment described herein, the guide surface 164 is interposed between the axis X and the blocking surface 162; the blocking surface 162 is then oriented radially inward, the guide surface 164 being oriented radially outward.

Here, the guide surface 164 is annular and substantially coaxial with the blocking surface 162. It is therefore positioned relative to the blocking surface 162 so that one of the guide surface 164 and the blocking surface 162 surrounds the other of the guide surface 164 and the blocking surface 162. In particular, in the first embodiment described herein, the blocking surface 162 surrounds the guide surface 164.

The guide surface 164 is translatably movable relative to the blocking surface 162 parallel to the blocking surface 162. In particular, it is translatably movable relative to the blocking surface 162 in the primary translation direction. For this purpose, the guide component 163 is, in the exemplary implementation described herein, movable relative to the frame 72 independently of the blocking surface 162.

The guide surface 164 is at a substantially fixed distance from the blocking surface 162, that is to say that it can neither move spaced from nor move toward the blocking surface 162. In other words, the guide surface 164 is substantially fixed in translation relative to the blocking surface 162 in a direction normal to the blocking surface 162.

The guide surface 164 is also translatably movable relative to the blocking member 166 in a secondary translation direction between a first configuration, shown in FIG. 4, and a second configuration, shown in FIG. 5. For this purpose, one of the guide component 163 and the blocking member 166 is constituted by a moving component 168 translatably movable relative to the frame 72 in said secondary translation direction, the other of the guide component 163 and the blocking member 166 being substantially fixed relative to the frame 72 in said secondary translation direction. In the exemplary implementation described herein, it is the guide component 163 which is constituted by said moving component 168.

The secondary translation direction is parallel to the blocking surface 162. In particular, it is parallel to the primary translation direction. The secondary translation direction is therefore here substantially parallel to the axis X.

The guide surface 164 is composed of a multitude of surface portions 170 juxtaposed with each other along the secondary translation direction. Each surface portion 170 is typically constituted by an elementary portion of the guide surface 164 which extends over the entire width of the guide surface 164 perpendicular to the secondary translation direction and which is of very small dimension parallel to said secondary translation direction. In an extreme case, each surface portion 170 is constituted by a line running along the guide surface 164 perpendicular to the secondary translation direction.

Each surface portion 170 is at a fixed distance d₀ from the blocking surface 162.

In the example shown, the guide surface 164 converges toward the blocking surface 162 parallel to the secondary translation direction. In other words, the distance from the guide surface 164 to the blocking surface 162 decreases from a first end 172 of the guide surface 164 to an opposite second end 174, parallel to the secondary translation direction. Thus, for each pair of juxtaposed surface portions 170, the one of said surface portions 170 which is closest to the second end 174 is at a distance d₀ from the blocking surface 162 which is less than or equal to the distance d₀ from the other surface portion 170 to the blocking surface 162.

The guide surface 164 converges toward the blocking surface 162 along a first direction of convergence. Preferably, said first direction of convergence is, as shown, oriented from the large pitch chamber 112 toward the small pitch chamber 114.

Here, the guide surface 164 converges continuously toward the blocking surface 162, that is to say that the distance from the guide surface 164 to the blocking surface 162 decreases continuously from the first end 172 to the second end 174. Advantageously, the slope of the guide surface 164 is substantially constant between the first end 172 and the second end 174.

Typically, the guide surface 164 is substantially smooth.

The blocking member 166 is positioned relative to the blocking surface 162 such that one of the blocking member 166 and the blocking surface 162 is interposed between the axis X and the other of the blocking member 166 and the blocking surface 162. Thus, in the first embodiment described herein, the blocking member 166 is interposed between the axis X and the blocking surface 162.

Preferably, the blocking member 166 is, as shown, annular and substantially coaxial with the blocking surface 162. It is therefore positioned relative to the blocking surface 162 such that one of the blocking member 166 and the blocking surface 162 surrounds the other of the blocking member 166 and the blocking surface 162. In particular, in the first embodiment described herein, the blocking surface 162 surrounds the blocking member 166.

The blocking member 166 is also substantially coaxial with the guide surface 164.

The blocking member 166 is translatably movable relative to the blocking surface 162 parallel to the blocking surface 162. In particular, it is translatably movable relative to the blocking surface 162 parallel to the primary translation direction.

The blocking member 166 is also movable relative to the blocking surface 162 in a direction perpendicular to said surface 162 between an unlocking configuration spaced from the blocking surface 162, shown in FIG. 4, and a locking configuration engaged with the blocking surface 162 so that the moving part 102 is immobilized relative to the frame 72, shown in FIG. 5.

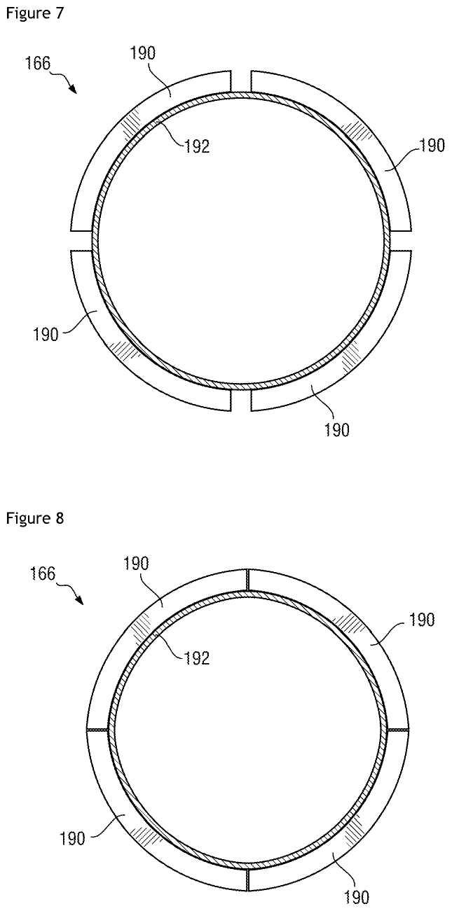

For this purpose, the blocking member 166 is here circumferentially divided into several segments 190 movable relative to each other between a close configuration, shown in FIG. 7, in which the blocking member 166 has a reduced diameter, and a spaced configuration, shown in FIG. 8, in which the blocking member 166 has an increased diameter. These segments 190 are at least two in number. Preferably, their number is greater than or equal to four. In the example shown, the segments 190 are four in number.

The diameter of the blocking member 166 can thus vary between a first value in which the blocking member 166 is spaced from the blocking surface 162, the blocking member 166 then being in the unlocking configuration, and a second value, in which the blocking member 166 is engaged with the blocking surface 162, the blocking member 166 then being in the locking configuration. Thus, one of the close and spaced configurations constitutes the unlocking configuration of the blocking member 166 and the other of the close and spaced configurations constitutes the locking configuration.

In particular, in the first embodiment described herein, the close configuration constitutes the unlocking configuration, the separated configuration constituting the unlocking configuration.

Each segment 190 is rigid. It is typically made of metal.

The blocking member 166 further comprises, advantageously, a biasing element 192 which urges the segments 190 toward that of the spaced and close configurations constituting the unlocking configuration. This biasing element 192 is here formed by an elastic ring, for example an O-ring, delimiting the interior of the blocking member 166 and to the exterior of which the segments 190 are attached. Thus, the unlocking configuration constitutes the configuration of the blocking member 166 when it is at rest.

As a variant (not shown), the blocking member 166 consists of a split sleeve. A split sleeve is, in known manner, an annular component interrupted by a slot. The lips of the bordering sleeve are movable relative to each other between a close configuration, in which the diameter of the sleeve is reduced, and a spaced-apart configuration, in which the diameter of the sleeve is increased. Thus, one of the close and spaced-apart configurations constitutes the unlocking configuration of the blocking member 166 and the other of the close and spaced-apart configurations constitutes the locking configuration.

Returning to FIGS. 4 and 5, the blocking member 166 has a blocking face 182 facing the blocking surface 162 and a guide face 184 facing the guide surface 164.

The blocking face 182 is substantially parallel to the blocking surface 162 in at least one of the locking and unlocking configurations of the blocking member 166. In the exemplary implementation described herein, the blocking face 182 is substantially parallel to the blocking surface 162 in both the locking configuration and the unlocking configuration of the blocking member 166.

The guide face 184 is composed of a multitude of face portions 186 juxtaposed with each other along the secondary translation direction. Each face portion 186 is typically constituted by an elementary portion of the guide face 184 which extends over the entire width of the guide face 184 perpendicular to the secondary translation direction and which is of very small dimension parallel to said secondary translation direction. In an extreme case, each face portion 186 is constituted by a line running along the guide face 184 perpendicular to the secondary translation direction.

In the example shown, the guide face 184 converges toward the blocking face 182 parallel to the secondary translation direction. In other words, the distance from the guide face 184 to the blocking face 182 decreases from a first end 187 of the guide face 184 to an opposite second end 188, parallel to the secondary translation direction. Thus, for each pair of juxtaposed face portions 186, that of said face portions 186 which is closest to the second end 188 is at a distance from the blocking face 182 which is less than or equal to the distance from the other face portion 186 to the blocking face 182.

The guide face 184 converges toward the blocking face 182 along a second direction of convergence. Preferably, said second direction of convergence has, as shown, the same orientation as the first direction of convergence. Here, the second direction of convergence is thus oriented from the large pitch chamber 112 toward the small pitch chamber 114.

Here, the guide face 184 converges continuously toward the blocking face 182, that is to say that the distance from the guide face 184 to the blocking face 182 decreases continuously from the first end 187 to the second end 188. Advantageously, the slope of the guide face 184 is substantially constant between the first end 187 and the second end 188.

Preferably, the guide face 184 is substantially parallel to the guide surface 164 in at least one of the locking and unlocking configurations of the blocking member 166. In the exemplary implementation described herein, the guide face 184 is substantially parallel to the guide surface 164 in both the locking configuration and the unlocking configuration of the blocking member 166.

Each face portion 186 is at a first distance d₁ (FIG. 5) from the blocking surface 162 when the blocking member 166 is in the locking configuration and at a second distance d₂ (FIG. 4) from the blocking surface 162 when the blocking member 166 is in the unlocking configuration. For at least a portion of the face portions 186, advantageously for each face portion 186, the first distance d₁ is less than the second distance d₂. Among said face portions 186, there is at least one face portion 186 for which the first distance d₁ is equal to the distance d₀ between the blocking surface 162 and a surface portion called corresponding surface portion 170.

In the exemplary implementation described herein, the first distance d₁ of each face portion 186 is less than the second distance d₂ of said face portion 186. For this purpose, each segment 190 is translatably movable perpendicular to the blocking surface 162 between the locking and unlocking configurations of the blocking member 166. Each segment 190 is in particular connected to the frame 72 by a connection 193 allowing this degree of freedom.

Moreover, in the exemplary implementation described herein, there is for several face portions 186 a corresponding surface portion 170 which is at a distance d₀ from the blocking surface 162 equal to the first distance d₁ from the face portion 186 to the blocking surface 162 when the blocking member 166 is in the locking configuration.

When the guide surface 164 and the blocking member 166 are in their first configuration (FIG. 4), each face portion 186 is spaced from the corresponding surface portion 170; the blocking member 166 is therefore free to be in its unlocking configuration.

When the guide surface 164 and the blocking member 166 are in their second configuration (FIG. 5), at least one face portion 186 bears against the corresponding surface portion 170 and is interposed between said corresponding surface portion 170 and the blocking surface 162; the blocking member 166 is then forced to be in its locking configuration. Here, several face portions 186 bear against the corresponding surface portions 170 and are interposed between said corresponding surface portions 170 and the blocking surface 162 when the guide surface 164 and the blocking member 166 are in their second configuration. Advantageously, the guide face 184 thus bears against the guide surface 164 over at least 50% of its axial length when the guide surface 164 and the blocking member 166 are in their second configuration.

The movement of the blocking member 166 relative to the guide surface 164 from the first configuration to the second configuration is oriented in the same direction as the first and second directions of convergence, that is to say here in a movement going from the large pitch chamber 112 to the small pitch chamber 114. Thus, the contact between the guide surface 164 and the guide face 184 is made progressively, which facilitates the movement of the blocking member 166 relative to the guide surface 164.

Still with reference to FIGS. 4 and 5, the moving component 168 is housed in a recess 194, here an annular recess centered on the axis X, formed in a support 195 integral with the frame 72. This recess 194 opens through an opening 196 in a face 197 of said support 195 which faces the blocking surface 162. It is delimited, opposite the blocking surface 162, by a bottom 198 set back relative to said face 197. It is also delimited, in the secondary translation direction, by two opposite end walls 199A, 199B.

The bottom 198 is in particular cylindrical and coaxial with the longitudinal axis X. The walls 199A, 199B are, themselves, substantially radial.

In the first embodiment described herein, said support 195 is constituted by the piston 106, the face 196 being constituted by the external face 109 of said piston 106.

Moreover, in the exemplary implementation described herein, the opening 196 extends from one to the other of the end walls 199A, 199B. It also extends, advantageously, over the entire circumference of the face 197.

Still in the exemplary implementation described herein, a first of the end walls 199A carries the connection 193 by which each segment 190 is connected to the frame 72

Still with reference to FIGS. 4 and 5, the locking device 160 further comprises a biasing member 200 which urges the guide surface 164 and the blocking member 166 toward the second configuration, and a holding device 202 for holding the guide surface 164 and the blocking member 166 in the first configuration under certain predetermined conditions, typically when the third pressure is greater than a threshold, said threshold being less than a minimum supply pressure of the fluid chambers 112, 114 under normal operating conditions. Such a minimum supply pressure of the fluid chambers 112, 114 under normal operating conditions is the minimum pressure supplied by the pressure generator 130 in the absence of any malfunction, in particular in the absence of a leak or breakdown.

The biasing member 200 is arranged so as to exert opposing forces on the guide surface 164 and on the blocking member 166, the force exerted on the guide surface 164 which urges said surface 164 toward the blocking member 166 and the force exerted on the blocking member 166 which urges said blocking member 166 toward the guide surface 164. In particular, the force exerted on the guide surface 164 is oriented in a direction opposite to the first and second directions of convergence and the force exerted on the blocking member 166 is oriented in the same direction as the first and second directions of convergence.

For this purpose, the biasing member 200 here comprises at least one compression spring compressed between a first shoulder 204 movable jointly with the moving component 168 in the secondary translation direction and a second shoulder 206 carried by the frame 72. In the exemplary implementation described herein, the second shoulder 206 is carried by the second wall 199B (that is to say by the wall delimiting the recess 194 opposite the wall 199A carrying the slide 193) and the first shoulder 204 is carried by the moving component 168.

The biasing member 200 comprises, for example, a single compression spring centered on the axis X. As a variant, it comprises a plurality of compression springs distributed circumferentially around the axis X.

By virtue of the biasing member 200, the configuration of the guide surface 164 and the blocking member 166 at rest is the second configuration. This allows to force the blocking member 166 into its locking configuration even in the event of a failure.

The holding device 202 comprises a counterbalancing actuator 210 having a counterbalancing piston 212 and a counterbalancing chamber 214.

The counterbalancing piston 212 is mounted to move in translation relative to the frame 72 in the secondary translation direction, jointly with the moving member 168. In the exemplary implementation described herein, it is integral and is in particular constituted by the moving member 168, which allows to gain in compactness.

The counterbalancing piston 212 is also substantially coaxial with the guide surface 164 and the blocking member 166.

The counterbalancing chamber 214 is delimited, along the secondary translation direction, between the counterbalancing piston 212 and the frame 72. The counterbalancing chamber 214 is thus in contact with the counterbalancing piston 212. In particular, in the exemplary implementation described herein, the counterbalancing chamber 214 is delimited, along the secondary translation direction, between the first wall 199A and the guide surface 164.

In the exemplary implementation described herein, the counterbalancing chamber 214 is also delimited, perpendicular to the blocking surface 162, between the bottom 198 and the blocking surface 162. For this purpose, the face 197 of the support 195 and the counterbalancing piston 212 each form a sealed contact, in particular a sealed annular contact, with the blocking surface 162.

The counterbalancing chamber 214 is fluidically connected to the pressure generator 130 by a fluid connection circuit 218 (FIG. 3) so as to be supplied with control fluid at the third pressure. It is intended to counterbalance the urge of the biasing device 200 when this supply is active.

For this purpose, the counterbalancing actuator 210 is arranged so that the pressure exerted on the piston 212 by the fluid contained in the chamber 214 is oriented in a direction opposite to that of the urge of the biasing device 200. Thus, here, the counterbalancing piston 212 is interposed between the chamber 214 and the biasing device 200, the shoulder 204 being interposed between the biasing device 200 and the piston 212. In addition, the counterbalancing piston 212 and the counterbalancing chamber 214 are dimensioned so that, when the chamber 214 is supplied with control fluid at a pressure above the threshold, the force exerted by the control fluid on the piston 212 is greater than the urge of the biasing device 200.

Thus, as long as the pressure supplied to the chamber 214 is greater than the threshold, the urge on the biasing device 200 is canceled, the guide surface 164 and the blocking member 166 being maintained in their first configuration. On the other hand, when the chamber 214 is no longer supplied with control fluid at a pressure greater than the threshold, typically when the pressure generator 130 fails, the force of the biasing device 200 prevails and the guide surface 164 and the blocking member 166 are switched into their second configuration.

Returning to FIG. 3, the pressure control unit 132 is here fluidly interposed between the pressure generator 130 and the fluid connection circuit 218. It has a first configuration, in which it isolates the fluid connection circuit 218 from the return line 136, and a second configuration, in which it fluidly connects the fluid connection circuit 218 to the return line 136.

The pressure control unit 132 is configured to normally be in its first configuration and to switch to its second configuration upon receiving a control instruction transmitted by the control module 135.

A method for changing the pitch of the blades 56, implemented by the pitch changing mechanism 70, will now be described.

In a first step of this method, the control module 135 first receives a setting instruction to increase the pitch of the blades 56. The control module 135 then transmits to the pressure control unit 132 a control signal to increase the fluid pressure in the first chamber 112. As the fluid pressure in the first chamber 112 increases, the moving part 102 of the actuator 74 moves in the second direction, toward its deployed position, which, via the connecting system 78, causes the blades 56 to pivot toward the large pitches (that is to say toward the feathered position).

Under the effect of the urge of the biasing element 192, the blocking member 166 remains in the unlocking configuration spaced from the blocking surface 162 and therefore does not oppose the movement of the moving part 102.

Once the moving part 102 has reached an equilibrium position, it stabilizes, the blades 56 maintaining a fixed orientation.

In a second step of the pitch change method, the control module 135 first receives a setting instruction to reduce the pitch of the blades 56. The control module 135 then transmits to the pressure control unit 132 a control signal to increase the fluid pressure in the second chamber 114. As the fluid pressure in the second chamber 114 increases, the moving part 102 of the actuator 74 moves in the first direction toward its retracted position, which, via the connecting system 78, causes the blades 56 to pivot toward the small pitches (that is to say, toward the zero thrust position).

Here again, under the effect of the urge of the biasing element 192, the blocking member 166 remains in the unlocking configuration spaced from the blocking surface 162 and therefore does not oppose the movement of the moving part 102.

Once the moving part 102 has reached an equilibrium position, it stabilizes, the blades 56 maintaining a fixed orientation.

Optionally, the pitch change method also comprises, after the first or second step, a step of controlled locking of the orientation of the blades 56.

During this step, the control module 135 transmits a pitch lock control to the pressure control unit 132. Under the effect of this control, the pressure control unit 132 fluidly connects the fluid connection circuit 218 to the return line 136, causing a drop in the fluid pressure in the counterbalancing chamber 214. The fluid pressure in said chamber 214 then falls below the threshold and is therefore insufficient to counterbalance the urge of the biasing device 200, which thus causes the movement of the moving component 168 along the axis X.

The guide surface 164 then presses on the guide face 184 of the blocking member 166. Since the guide surface 164 and the guide face 184 are each inclined relative to the longitudinal direction (since the guide surface 164 converges toward the blocking surface 162 and the guide face 184 converges toward the blocking face 182), the bearing force of the guide surface 164 on the guide face 184 has a radial component (which would also be the case if only the guide surface 164 or the guide face 184 were inclined relative to the longitudinal direction). The guide surface 164 therefore pushes the blocking member 166 toward the blocking surface 162.

The blocking member 166 thus moves, under the effect of this thrust, toward the blocking surface 162 until the blocking member 166 is engaged with the blocking surface 162. There, the movement of the moving component 168 along the axis X stops, which can only take place jointly with the movement of the blocking member 166 toward the blocking surface 162, which is then prevented.

The force of the biasing device 200 on the movable member 168 is then converted into a force of pressing the blocking member 166 on the blocking surface 162 by wedge effect. This creates an adhesion force at the interface between the blocking member 166 and the blocking surface 162 which blocks any movement of the blocking surface 162 relative to the blocking member 166.

The moving part 102 can then no longer move relative to the fixed part 100. The blades 56 are thus blocked in their orientation even in the event of loss of fluid pressure in one of the chambers 112, 114.

In the event of a malfunction of the control system 76, typically in the event of a failure of the pressure generator 130, the pitch change method comprises an additional step of non-controlled locking of the orientation of the blades 56.

During this step, the malfunction of the control system 76 causes a drop in the fluid pressure in the counterbalancing chamber 214, typically because the pressure generator 130 is no longer able to raise the third pressure beyond the threshold. The fluid pressure in said chamber 214 is then insufficient to counterbalance the urge of the biasing device 200, which thus causes the movement of the moving component 168 along the axis X.

The guide surface 164 then presses on the guide face 184 of the blocking member 166. Since the guide surface 164 and the guide face 184 are each inclined relative to the longitudinal direction (since the guide surface 164 converges toward the blocking surface 162 and the guide face 184 converges toward the blocking face 182), the bearing force of the guide surface 164 on the guide face 184 has a radial component (which would also be the case if only the guide surface 164 or the guide face 184 were inclined relative to the longitudinal direction). The guide surface 164 therefore pushes the blocking member 166 toward the blocking surface 162.

The blocking member 166 thus moves, under the effect of this thrust, toward the blocking surface 162 until the blocking member 166 is engaged with the blocking surface 162. There, the movement of the moving component 168 along the axis X stops, which can only take place jointly with the movement of the blocking member 166 toward the blocking surface 162, which is then prevented.

The force of the biasing device 200 on the movable member 168 is then converted into a force of pressing the blocking member 166 on the blocking surface 162 by wedge effect. This creates an adhesion force at the interface between the blocking member 166 and the blocking surface 162 which blocks any movement of the blocking surface 162 relative to the blocking member 166.

The moving part 102 can then no longer move relative to the fixed part 100. The blades 56 are thus blocked in their orientation.

The non-controlled locking step is preferably followed by a step of securing the fan 50. During this step, the emergency circuit 134 is activated and supplies the first fluid chamber 112 and the counterbalancing chamber 214 with control fluid so as to increase the fluid pressure in these chambers. Under the effect of the increase in pressure in the chamber 214, the bearing force of the blocking member 166 on the blocking surface 162 disappears. There is then no longer any adhesion between the blocking member 166 and the blocking surface 162 (or at least this adhesion becomes very weak). The moving part 102 is therefore no longer immobilized and can move downstream under the effect of the increase in pressure in the first fluid chamber 112 until the blades 56 are in the feathered position.

It should be noted that these different steps can be implemented independently of each other.

Thus, thanks to the exemplary embodiment described above, it is possible, in a simple and robust manner, to lock the current orientation of the blades 56 (with a certain tolerance). This locking is made possible even in the absence of power supply to the actuator 74 and even with a small force. And this locking is permitted without a significant increase in the size of the mechanism 70.

In particular, the first embodiment described above proves to be advantageous in that it is particularly radially compact and simplifies the design of the mechanism 70 by facilitating the supply of the counterbalancing chamber 214 via the oil transfer bearing 84.

A second embodiment of the pitch-change mechanism 70 will now be described, with reference to FIGS. 9 to 15.

This second embodiment differs from the first embodiment in that the locking device is arranged radially outside the control actuator 74 and in particular surrounds the control actuator 74. Thus, in this second embodiment:
the blocking surface 162 constitutes an external surface of the cylinder 104,
the blocking surface 162 is interposed between the axis X and the guide surface 164,
the blocking surface 162 is oriented radially outwards, the guide surface 164 being oriented radially inwards,
the guide surface 164 surrounds the blocking surface 162,
the blocking surface 162 is interposed between the axis X and the blocking member 166,
the blocking member 166 surrounds the blocking surface 162,
the spaced-apart configuration of the blocking member 166 constitutes its unlocking configuration, the close configuration constituting its locking configuration,
the support 185 is arranged radially outside the blocking member 166 and the control actuator 74,
the support 185 extends around the blocking member 164, and
the face 186 constitutes an internal face, oriented toward the axis X, of said support 185.

This second embodiment allows, compared to the first embodiment described above, to have a counterbalancing chamber 214 of larger radial section, which allows to use a biasing member 200 exerting a greater force, and thus to increase the blocking force of the locking device 160.

Moreover, in this second embodiment, the synchronization crown 140 is fixed to an upstream end 143 of the moving part 102 rather than to the middle portion of the moving part 102. This is the result of the gain in longitudinal compactness allowed by the second embodiment.

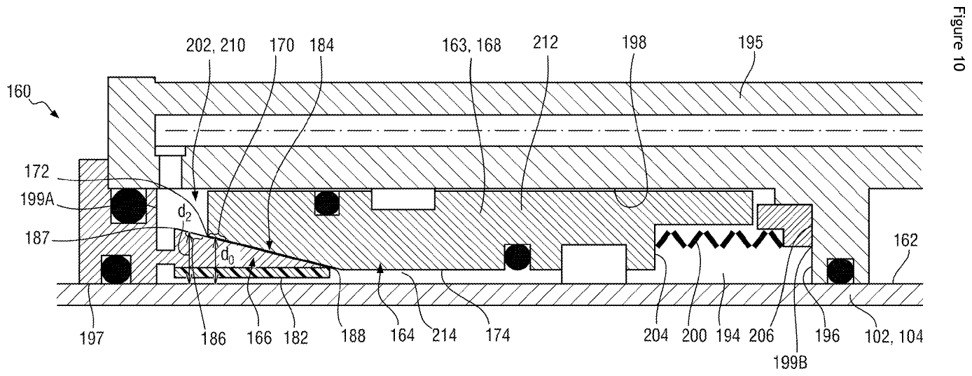

Other exemplary implementations of the locking device 160 will now be described, with reference to FIGS. 10 to 15. It will be noted that, although these other exemplary implementations are described in relation to the second embodiment with the locking device arranged radially outside the control actuator 74, they are also applicable to the first embodiment with the locking device 160 arranged inside the control actuator 74.

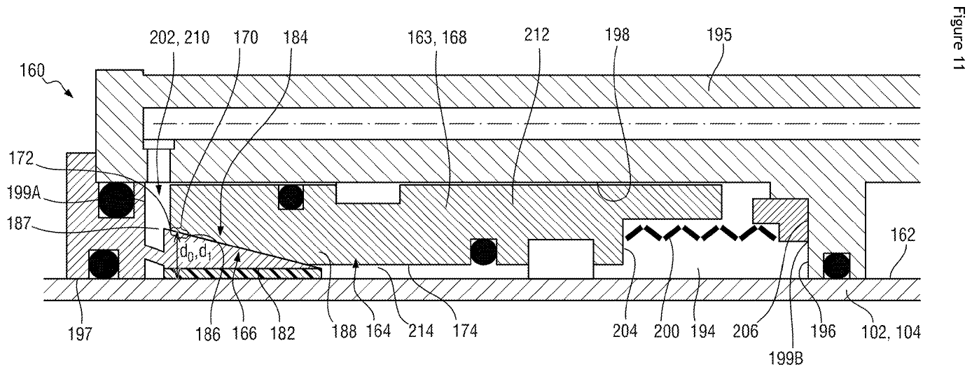

A first variant implementation of the locking device 160 is shown in FIGS. 10 and 11, FIG. 10 showing the blocking member 166 and the guide surface 164 in their first configuration, FIG. 11 showing the blocking member 166 and the guide surface 164 in their second configuration. This first variant is identical to the first implementation described above.

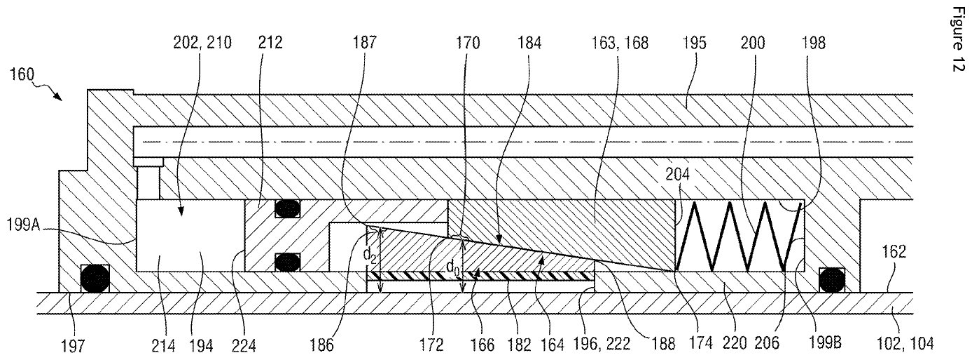

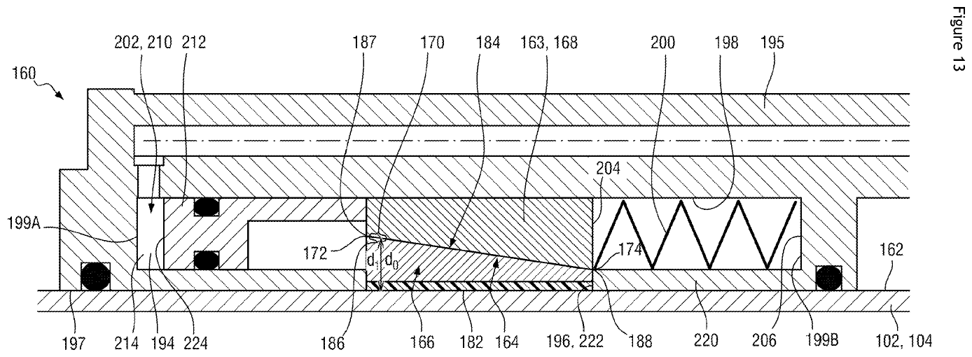

A second variant implementation of the locking device 160 is shown in FIGS. 12 and 13, FIG. 12 showing the blocking member 166 and the guide surface 164 in their first configuration, FIG. 13 showing the blocking member 166 and the guide surface 164 in their second configuration. This second alternative differs from the first implementation described above by several features.

First of all, the opening 196 through which the recess 194 opens into the face 197 of the support 195 does not extend from one to the other of the walls 199A, 199B of the recess 194. Instead, the recess 194 is partly closed by a wall 220 opposite the bottom 195 and interposed between the bottom 195 and the blocking surface 162. The opening 196 is formed by a groove 222 formed through said wall 220. In particular, the wall 220 is cylindrical and the groove 222 is annular and substantially coaxial with the wall 220.

Then, each segment 190 of the blocking member 166 is not connected to the frame 72 by a connection 193 carried by the first wall 199A of the recess 194. Instead, each segment 190 has a longitudinal extension slightly less than the longitudinal extension of the groove 222 and is engaged in said groove 222. The groove 222 thus acts as a guide to guide the radial translation of each segment 190 relative to the blocking surface 162 while immobilizing the blocking member 166 in the longitudinal direction X relative to the frame 72.

A further difference lies in the fact that the counterbalancing chamber 214 is not delimited longitudinally between the first wall 199A and the guide surface 164 and radially between the bottom 195 of the recess 194 and the blocking surface 162. Instead, the counterbalancing chamber 214 is delimited longitudinally between the first wall 199A and a face 224 of the counterbalancing piston 212 distinct from the guide surface 164, and radially between the bottom 195 and the wall 220. The guide surface 164 and the blocking member 166 are arranged outside the counterbalancing chamber 214; in particular, the guide component 163 and the blocking member 166 are each interposed between said face 224 of the piston 212 and the biasing member 200. This prevents control fluid from entering between the blocking face 182 and the blocking surface 162, which allows to increase the coefficient of adhesion between the blocking member 166 and the blocking surface 162. The locking of the locking device 160 is thus more effective.

Finally, the counterbalancing piston 212 is not integral with the moving component 168. It is simply interposed between the counterbalancing chamber 214 and the moving component 168, which allows it to be held pressed against the moving component 208 thanks to the opposing pressures exerted, on the one hand, by the fluid present in the chamber 214 on the piston 212 and, on the other hand, by the biasing member 200 on the moving component 208, and therefore to move jointly with the moving component 208 in the secondary translation direction. It will nevertheless be noted that this latter difference is optional and that the counterbalancing piston 212 can also be integral with the moving component 168, as in the other variants.

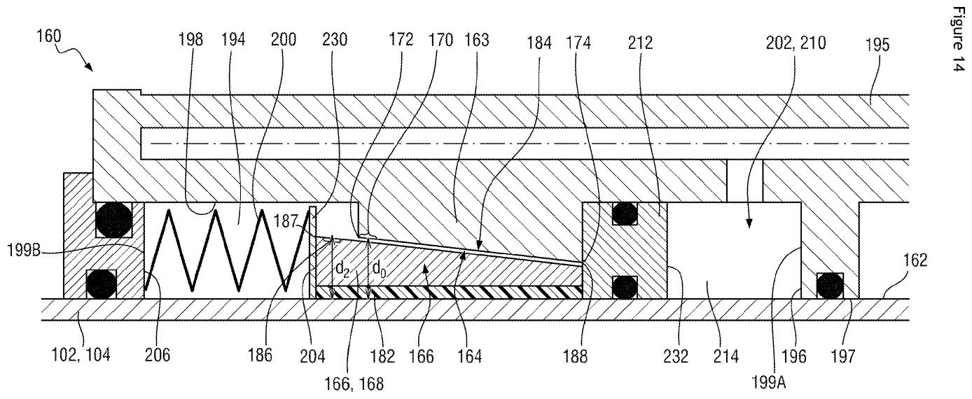

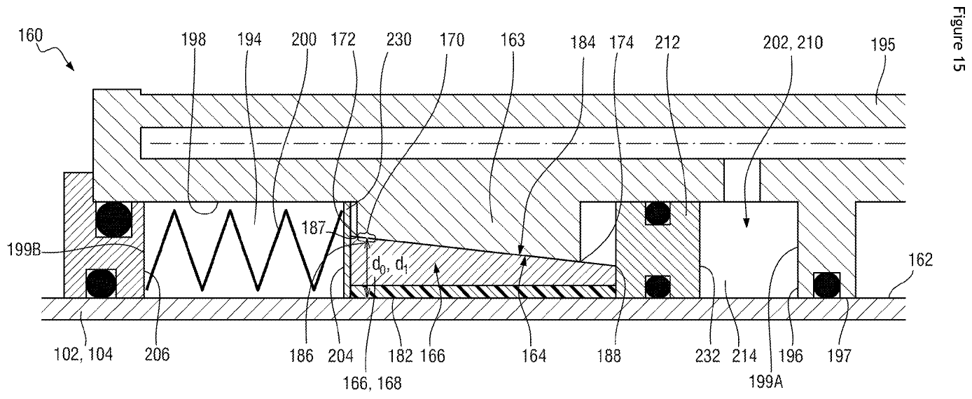

A third alternative implementation of the locking device 160 is shown in FIGS. 14 and 15, FIG. 14 showing the blocking member 166 and the guide surface 164 in their first configuration, FIG. 15 showing the blocking member 166 and the guide surface 164 in their second configuration. This second variant differs from the first implementation described above by several features.

First of all, the guide component 163 is integral with the frame 72, the moving component 168 being constituted by the blocking member 166.

Then, the shoulder 204 is not carried by the moving component 168. Instead, the shoulder 204 is carried by a plate 230 interposed between the biasing member 200 and the moving component 168. This plate 230 is substantially fixed in radial translation. It will nevertheless be noted that this plate 230 is optional and that the shoulder 204 can also be carried by the moving component 168 as in the other variants.

Another difference lies in the fact that the counterbalancing chamber 214 is not delimited longitudinally between the first wall 199A and the guide surface 164. Instead, the counterbalancing chamber 214 is delimited longitudinally between the first wall 199A and a face 232 of the counterbalancing piston 212 distinct from the guide surface 164. The guide surface 164 and the blocking member 166 are arranged outside the counterbalancing chamber 214; in particular, the guide component 163 and the blocking member 166 are each interposed between said face 232 of the piston 212 and the biasing member 200.

An additional difference lies in the fact that the counterbalancing piston 212 is not integral with the moving component 168. It is simply interposed between the counterbalancing chamber 214 and the moving component 168, which allows it to be held pressed against the moving component 208 thanks to the opposing pressures exerted, on the one hand, by the fluid present in the chamber 214 on the piston 212 and, on the other hand, by the biasing member 200 on the moving component 208, and therefore to move jointly with the moving component 208 in the secondary translation direction.

Finally, each segment 190 of the blocking member 166 is not connected to the frame by a connection 193 carried by the first wall 199A of the recess 194. Instead, each segment 190 is interposed longitudinally between the plate 230 and the piston 212, which thus act as a guide to guide the radial translation of each segment 190 relative to the blocking surface 162 while accompanying the movement of the blocking member 166 along the longitudinal direction X relative to the frame 72.

This latter variant is advantageous in that it allows the fan 50 to be secured without having to re-supply the counterbalancing chamber 214. Indeed, in the event of an increase in pressure in the large pitch chamber 112, the blocking member 166 will, via the adhesion forces, be urged spaced from the guide surface 164, thus reducing the adhesion forces which will then be insufficient to oppose the movement of the moving part 102 relative to the fixed part 100.

It will be noted that, although the above description has been given for exemplary embodiments in which the cylindrical surface 162 is movable jointly with the moving part 102 relative to the frame 72, the invention is in no way limited to this single case. Thus, in other exemplary embodiments (not shown), it is the blocking member 166 which is movable jointly with the moving part 102 relative to the frame 72, the cylindrical surface 162 then being integral with the frame 72. The person skilled in the art will easily be able to make the necessary adaptations.

1. A pitch-change mechanism for adjusting an angular position of at least one variable-setting blade of an aircraft turbomachine around a pivot axis of the variable-setting blade, said pitch-change mechanism comprising:
a frame fixed relative to the pivot axis,
a control actuator including a fixed part integral with the frame and a moving part,
a connecting system connecting the moving part to the variable-setting blade so as to convert movement of the moving part relative to the fixed part into a rotation of the variable-setting blade around the pivot axis, and
a pitch locking device suitable for blocking the movement of the moving part relative to the fixed part in at least one direction,
wherein the pitch locking device comprises:
a blocking surface integral with the frame or movable jointly with the moving part relative to the frame,
a guide surface facing the blocking surface and comprising a surface portion at a fixed first distance from the blocking surface,
a blocking member interposed between the blocking surface and the guide surface and having a guide face facing the guide surface, said blocking member having an unlocking configuration spaced from the blocking surface, in which a face portion of the guide face is at a second distance from the blocking surface, greater than the first distance, and a locking configuration engaged with the blocking surface so that the moving part is immobilized relative to the frame, in which the face portion is at the first distance from the blocking surface,
the guide surface and the blocking member being movable relative to each other parallel to the blocking surface between a first configuration, in which the surface portion is spaced from the face portion, and a second configuration in which the face portion bears against the surface portion,
the pitch locking device further comprising:
a biasing member which exerts an urge on the guide surface or the blocking member toward the second configuration, and
a holding device for holding the guide surface and the blocking member in the first configuration under certain predetermined conditions.
wherein the guide surface converges toward the blocking surface so that, when the guide surface and the blocking member are in the second configuration, the force of the biasing device on the guide surface or the blocking member is converted into a force of pressing the blocking member on the blocking surface by wedge effect, this creating an adhesion force at the interface between the blocking member and the blocking surface, the biasing device being dimensioned so that said adhesion force blocks any movement of the blocking surface relative to the blocking member.

2. The pitch-change mechanism according to claim 1, wherein the guide surface converges toward the blocking surface in a first direction, the biasing member exerting on the guide surface a force oriented in a second direction opposite to the first direction and/or exerting on the blocking member a force oriented in said first direction.

3. The pitch-change mechanism according to claim 1, wherein the blocking member comprises a blocking face facing the blocking surface, the guide face converging toward said blocking face.

4. The pitch-change mechanism according to claim 1, wherein the guide face is substantially parallel to the guide surface.

5. The pitch-change mechanism according to claim 1, wherein the blocking surface is cylindrical and the blocking member is annular and substantially coaxial with the blocking surface, the blocking member being circumferentially divided into several segments movable relative to each other between a close configuration, in which the blocking member has a reduced diameter, and a spaced configuration, in which the blocking member has an increased diameter, the close configuration constituting one of the locking and unlocking configurations of the blocking member and the spaced configuration constituting the other of said locking and unlocking configurations.

6. The pitch-change mechanism according to claim 1, wherein the holding device comprises a counterbalancing actuator with a counterbalancing chamber in contact with a piston movable together with the guide surface or the blocking member, said counterbalancing chamber being capable of receiving a pressurized fluid to counterbalance the urge of the biasing device.

7. The pitch-change mechanism according to claim 1, wherein the fixed portion and the movable portion define therebetween two fluid chambers arranged so that an increase in a fluid pressure in one of the fluid chambers relative to a fluid pressure in the other fluid chamber causes the movable portion to move relative to the fixed portion, the predetermined conditions consisting of a supply pressure of the fluid chambers greater than a threshold, said threshold being lower than a minimum supply pressure of the fluid chambers under normal operating conditions.

8. A fan rotor for a turbomachine comprising a hub and a plurality of variable-setting blades each pivotable relative to the hub around a specific pivot axis, the rotor further comprising the pitch-change mechanism according to claim 1 for adjusting an angular position of each of the variable-setting blades around its respective pivot axis.

9. A gas turbine engine comprising a fan rotor according to claim 8.

10. An aircraft comprising the gas turbine engine according to claim 9.

11. A method for changing the pitch of blades of a fan rotor for a turbomachine, each pivotable relative to a hub of the fan rotor around a specific pivot axis, said method comprising adjusting an angular position of each of said blades around its respective pivot axis by means of the pitch changing mechanism according to claim 1.
